(19) United States
(12) Patent Application Publication
(10) Pub. No.: US 2011/0013128 A1
(43) Pub. Date: Jan. 20, 2011

(54) DYNAMIC DISPLAY WITH DIVIDED TOP ELECTRODE

(75) Inventor: Michael G. GINN, Essex (GB)

Correspondence Address: Avery Dennison Corporation;Amanda Wittine, 8080 Norton Parkway, 22-D, Mentor, OH, 44060, US

(73) Assignee: AVERY DENNISON CORPORATION, Pasadena, CA (US)

(21) Appl. No.: 12/838,662

(22) Filed: Jul. 19, 2010

Related U.S. Application Data
(60) Provisional application No. 61/227,047, filed on Jul. 20, 2009.

(51) Int. Cl. G02F 1/1333

(52) U.S. Cl. 349/122

(57) ABSTRACT

The present invention relates generally to dynamically addressable displays, such as electrophoretic and other like bi-stable and/or non-volatile displays to provide an individually addressable series of segments on a multi-element display arrangement.

### CROSS-REFERENCE TO RELATED APPLICATION

The present application claims the benefit of U.S. Provisional Application No. 61/227,047 filed Jul. 20, 2009, which is incorporated herein by reference in its entirety.

### FIELD OF THE INVENTION

The present invention is found in the field of dynamically addressable displays such as those used in connection with conveying information in a retail or other merchandising environment.

### BACKGROUND OF THE INVENTION

The present inventive subject matter relates generally to the art of electrophoretic and other like bi-stable and/or non-volatile display technologies. Particular relevance is found in connection with 7-segment and/or other multi-element displays, and accordingly the present specification makes specific reference thereto. However, it is to be appreciated that aspects of the present inventive subject matter are also equally amenable to other like applications.

Electrophoretic and other like bi-stable and/or non-volatile display technologies (sometimes referred to as electronic ink) are generally known in the art. See, e.g., United States Patent Publication Nos. US 2002/0167500 A1; US 2005/0263903 and US 2005/0134461 A1; all incorporated herein by reference in their entirety. Additionally, 7-segment and/or other like multi-element displays are generally known. It is also known to use electrophoretic and other like bi-stable and/or non-volatile display technologies in 7-segment and/or other like multi-element displays.

Conventionally, a single 7-segment or multi-element display is provisioned to selectively depict a single alpha-numeric or other like character by selectively controlling the state (e.g., on or off) of each individual element or segment within the particular display. As can be appreciated, a single 7-segment or other like multi-element display can selectively output one of a variety of different characters depending on the pattern generated by the respective states of the individual segments or elements.

In a 7-segment or other multi-element display employing electrophoretic or other like bi-stable and/or non-volatile display technology, generally, each individual segment or element is selectively switched between respective states as desired by the selective application of an electric and/or magnetic field generated between two electrodes on opposing sides of the segment or element under control. Commonly, each segment or element is individually addressable by a display driver or controller (e.g., a micro-processor or the like) operatively connected to the aforementioned electrodes.

Often, a plurality of 7-segment and/or multi-element displays are combined to produce an overall display capable of selectively depicting a plurality of individual characters. The overall display often may include a plurality of rows with each row containing one or more of the selectively displayable characters. With reference now to FIG. 1, there is shown a top view of such an overall display. In the illustrated example, the overall display 10 includes three rows 12a through 12c of selectively displayable characters, with each row including five selectively displayable characters and each selectively displayable character being produced by a corresponding multi-element display 14a through 14o. In this example, each multi-element display is a 7-segment display including segments 20a through 20g.

With reference now to FIG. 2, there is shown a side cross-section view of the overall display 10 shown in FIG. 1 in accordance with an exemplary conventional embodiment thereof. In particular, the overall display 10 includes an active film or layer 30 that is locally responsive to electric and/or magnetic fields. That is to say, at the location where an electric or magnetic field is applied across the active film or layer 30, the active film or layer 30 changes its color or reflectance or absorption or opacity or another like visually perceivable quality in response to the applied electric and/or magnetic field. For example, this change is achieved by an electrophoretic effect or other like phenomena or a similar mechanism experienced in and/or by the active layer 30. To apply the electric and/or magnetic fields, electrodes on opposing sides of the active layer 30 are energized and/or otherwise used.

In the illustrated example, on a first side of the active layer 30, a common electrode 32 is arranged, and on the other or second side of the active layer 30, a backplane 34 is arranged, e.g., which may include a printed circuit board (PCB) or the like. The backplane 34 generally includes a plurality of distinct operative connections to a plurality of distinct electrodes on the second side of the active layer 30; namely, one connection and/or electrode for each of the segments in the overall display 10. The common electrode 32, on the other hand, serves as the opposing electrode for all the segments in the overall display 10. Accordingly, to individually address (e.g., with a display driver or controller) any particular segment in the overall display 10, the driver/controller employs the common electrode 32 in conjunction with the particular electrode and/or connection in the backplane 34 assigned to and/or designated for the segment one desires to control.

While the foregoing approach and/or arrangement works relatively well, it can be inefficient and/or cumbersome in some respects. For example, in conjunction with the backplane 34, a unique connection and/or electrode has to be established and/or maintained for each segment in the overall display 10. In this case, that equates to 105 connections, i.e., 3 rows by 5 characters in each row by 7 segments per character (3×5×7=105). As can be appreciated, each additional distinct connection that has to be made can further increase the total production cost and/or complexity of the overall display 10.

Accordingly, a new and/or improved display is disclosed herein which addresses the above-referenced problem(s) and/or others.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one exemplary embodiment of the presently described invention, a dynamic display is provided and includes an active film layer that has first and second sides, with a first electrode disposed over the first side and a second electrode disposed over the second side.

The display device of the present invention provides a display that is independently addressable by activating only select portions of the display despite the activation of the entire electrode layer.

The presently described embodiment also includes a backplane that is disposed between the first side of the film layer and the first electrode and has a plurality of connections to the first electrode. The first electrode divided into a plurality of rows or columns. The second electrode is also divided into a plurality of rows or columns. A display driver is connected to each of the electrodes.

A plurality of multi-element displays is provided for selectively displaying a plurality of variable characters, each of the multi-element displays selectively depicts one of an alpha-numeric or other character by selectively controlling the state of each individual element within the particular display. The multi-element displays are arranged in a matrix or two-dimensional array including a plurality of rows or columns, with each row or column including one or more of the multi-element displays and each row or column of the multi-element displays corresponding to at least the row or column of the second electrode.

In a still further exemplary embodiment of the presently described invention a method of using a using a display is presented and includes the steps of, initially providing a multi-element display that has first and second electrodes disposed on either side of an active film layer, with each of the first and second electrodes divided into one or more rows or columns. Then a display driver is connected to the first and second electrodes. The active film layer is energized to provide an electric or magnetic field to a particular segment of the active film layer. The second electrode is connected through the active film layer to the first electrode; and a display is created on the particular segment and not all of the film while the first electrode is energized.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWING(S)

The inventive subject matter disclosed herein may take form in various components and arrangements of components, and in various steps and arrangements of steps. The drawings are only for purposes of illustrating preferred embodiments and are not to be construed as limiting. Further, it is to be appreciated that the drawings may not be to scale.

FIG. 1 is a top view of an overall display employing a plurality of multi-element displays for selectively displaying a plurality of variable characters within the overall display;

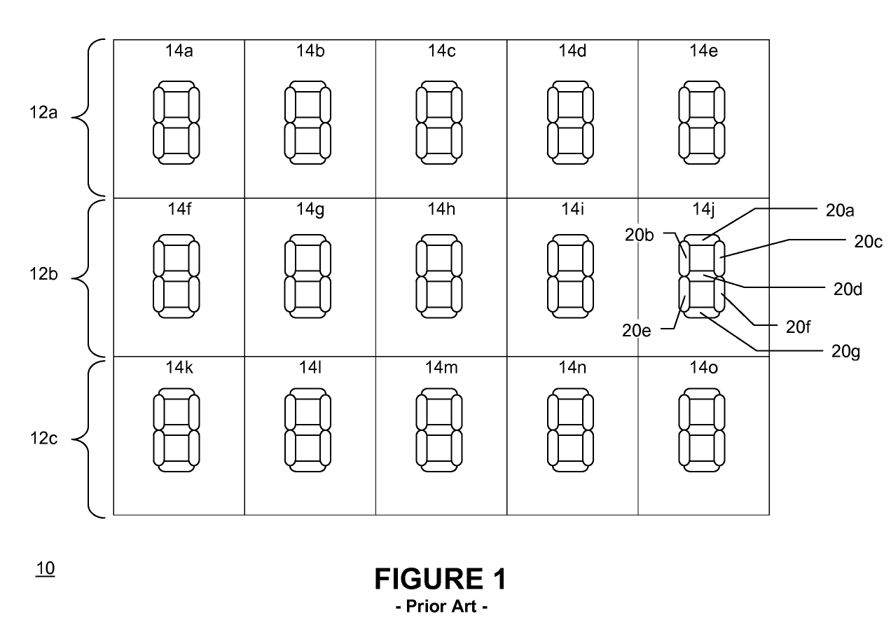

FIG. 2 is a cross-sectional side view of the display from FIG. 1 in accordance with a conventional embodiment thereof;

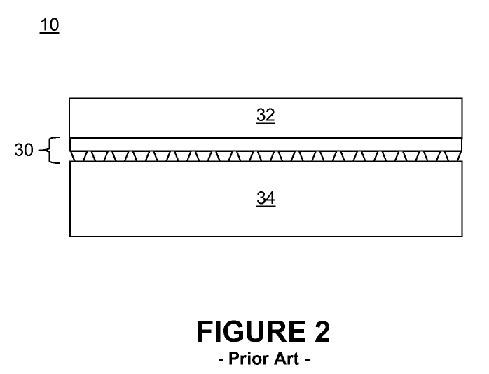

FIG. 3 is a top view of an overall display apparatus employing a plurality of multi-element displays for selectively displaying a plurality of variable characters in accordance with aspects of the present inventive subject matter; and

FIG. 4 is a cross-sectional side view of the display from FIG. 3 in accordance with an exemplary embodiment of the present inventive subject matter.

### DETAILED DESCRIPTION OF THE EMBODIMENT(S)

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

Dynamic displays, those that are changeable or updatable electronically, such as through the reception of wireless signals, are regularly being considered for use in retailing and other merchandising applications. In such applications, the retailer or manufacturer can remotely change the price or other information relating to the product to which the addressable device has been attached.

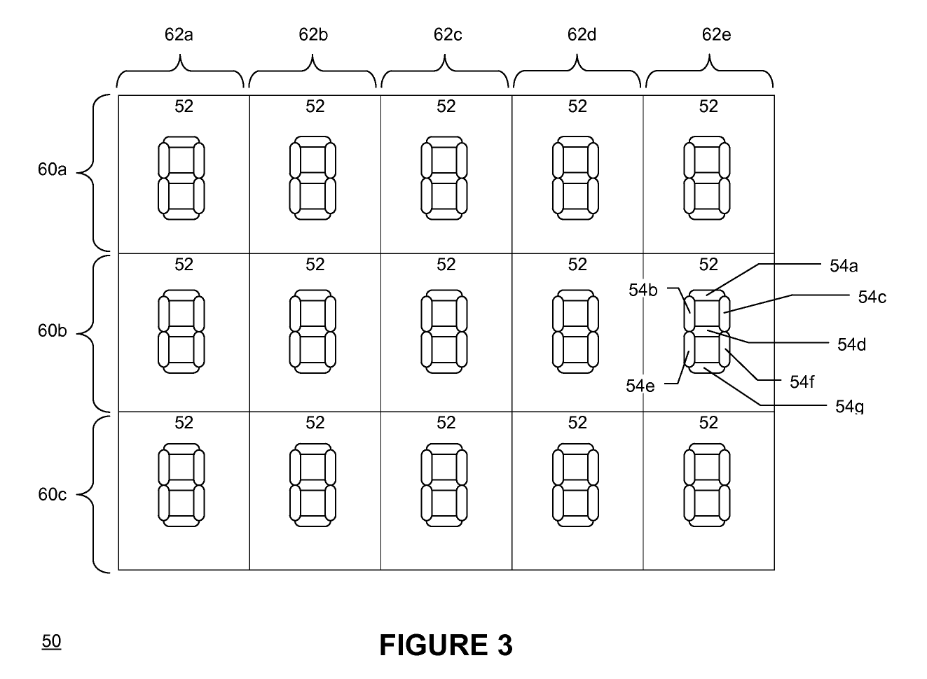

With reference to FIG. 3, in general, there is disclosed herein a display apparatus including a plurality of multi-element displays employing an electrophoretic or another suitable bi-stable and/or non-volatile display technology. Each multi-element display is provisioned to selectively depict an alpha-numeric or other like character by selectively controlling the state (e.g., on or off) of each individual element or segment within the particular display or section of the display. Suitably, each multi-element display is employed to selectively output one of a variety of different characters depending on the pattern generated by the respective states of the individual segments of the elements within each multi-element display. Suitably, the multi-element displays are arranged in a matrix or two-dimensional array, e.g., including a plurality of rows through and/or columns through, with each row and/or column including one or more of the multi-element displays. In one suitable example, each multi-element display is optionally a 7-segment display, that is there are seven individual segments that are selectively activated to create a character within the portion or area of the display selected to show the particular character.

In practice, the overall display apparatus is constructed from an active film or layer arranged between opposing electrodes on either side thereof. Suitably, the active film or layer is locally responsive to electric and/or magnetic fields. That is to say, at the location where an electric or magnetic field is applied across the active film or layer, the active film or layer changes its color (darkens or lightens) or reflectance or absorption or opacity or another like visually perceivable quality in response to the applied electric and/or magnetic field. For example, this change is achieved by an electrophoretic effect or other like phenomena or a similar mechanism experienced in and/or by the active layer. In a suitable embodiment, the visually observable state change is achieved via one of the mechanisism described in one of the above-mentioned patent applications.

In general, to apply the electric and/or magnetic fields, electrodes on opposing sides of the active layer are energized and/or otherwise used. Suitably, each element in the overall display apparatus is individually addressable by a display driver and/or controller (e.g., a micro-processor or the like) operatively connected to the aforementioned electrodes.

In one suitable embodiment, on a first side of the active layer, a backplane or the like is optionally arranged including a plurality of operative connections to a plurality of first side electrodes. Optionally, the plurality of first side electrodes includes one electrode underlying and/or corresponding to every element in each multi-element display of the overall display apparatus. Suitably, for all the multi-element displays residing in a common column, a single common connection exists and/or is optionally employed to address all the first side electrodes corresponding to those elements sharing the same relative location within their respect multi-element displays. That is to say, optionally, the first side electrodes corresponding to elements all sharing the same relative location within the respective multi-element displays residing in a common column of the overall display apparatus are operatively tied together.

On the other or second side of the active layer, a divided second side electrode layer is formed or otherwise arranged. That is to say, the second side electrode layer is divided into a plurality of distinct conductors and/or electrodes. Suitably, each distinct conductor/electrode in the second side electrode layer overlies and/or corresponds to one of the rows in the overall display apparatus.

Consequently, to individually address (e.g., with the display driver/controller) any particular element in the overall display apparatus, the driver/controller merely employs: (1) the distinct second side conductor/electrode corresponding to the row in which the multi-element display device resides that contains the element of interest (i.e., the element to be controlled); in conjunction with, (2) the particular connection in the backplane assigned to and/or designated for (i) the column in which the multi-element display device resides which contains the element of interest, and (ii) the relative element location one desires to control within the multi-element display.

In short, dividing the second electrode layer in this way allows for multiplexed control of the overall display apparatus. By multiplexing control of the overall display apparatus in this manner, the total number of connections can be significantly reduced, e.g., as compared to like displays having a single common electrode on one side of the active layer. To illustrate this point, consider an overall display apparatus having a 3×5 array of multi-element displays, each including 7 segments or elements (which is comparable in array size and/or total element count to the example given in the Background section provided above). Using the multiplex-controllable arrangement disclosed herein (i.e., with the divided second electrode layer), comparatively, the 105 backplane connections of the prior art approach can be reduced to 35 backplane connections. Even considering that additional connections may have to be made to the second electrode layer in order to select the distinct row of interest for control, the overall number of connections can still be reduced. For example, continuing with the above-comparison, the prior art approach would have 106 total connections (i.e., 105 in the backplane plus 1 for the common electrode on the other side of the active layer), while with the present arrangement (i.e., having a divided second side electrode layer) the total number of connections would be only 38 (i.e., 35 backplane connections plus three for the divided electrode on the other side of the active layer).

With reference now to FIG. 3, there is shown an exemplary display apparatus 50 including a plurality of multi-element displays 52 employing an electrophoretic or another suitable bi-stable and/or non-volatile display technology. Each multi-element display 52 is provisioned to selectively depict an alpha-numeric or other like character by selectively controlling the state (e.g., on or off) of each individual element 54a through 54g within the particular display. Suitably, each multi-element display 52 is employed to selectively output one of a variety of different characters depending on the pattern generated by the respective states of the individual elements 54a-g within each multi-element display 52. Suitably, the multi-element displays are arranged in a matrix or two-dimensional (2D) array. In the illustrated example, a 3×5 array is shown including a plurality of rows 60a through 60c and/or columns 62a through 62e, with each row and/or column including one or more of the multi-element displays 52. However, it is to be appreciated that in practice the array dimensions may be otherwise, e.g., with each row and/or column including any practical number of multi-element displays. Moreover, it is to be appreciated that for convenience and/or clarity herein, the term “row” has been used to identify the horizontal orientation of the 2D matrix or array relative to the corresponding FIGURE and the term “column” has been used herein to identify the vertical orientation of the 2D matrix or array relative to the corresponding FIGURE. However, in practice, these terms may refer to arbitrary orientations. That is to say, e.g., the row of the 2D matrix may correspond to the vertical orientation while the column of the 2D matrix may correspond to the horizontal orientation.

In the illustrated example, each multi-element display 52 is optionally a 7-segment display, i.e., having seven elements 54a-g each. In particular, each multi-element display 52 includes: a top element or segment 54a, a top left-side element or segment 54b, a top right-side element or segment 54c, a middle element or segment 54d, a bottom left-side element or segment 54e, a bottom right-side element or segment 54f, and a bottom element or segment 54g. However, in practice, it is to be appreciated that each multi-element display 52 may optionally have some other practical number and/or arrangement of elements, i.e., more or less than seven.

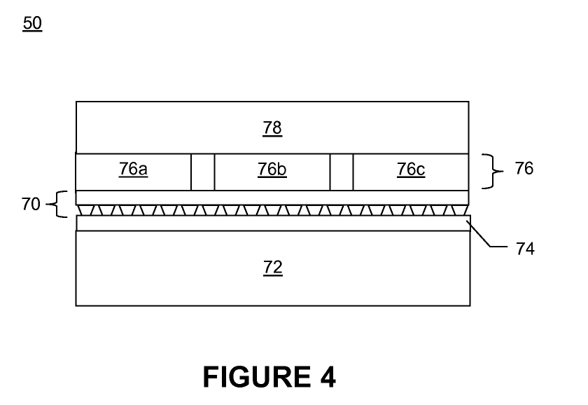

With reference now to FIG. 4, the overall display apparatus 50 is constructed from an active film or layer 70, having first and second sides and arranged between opposing electrode layers on either side thereof, that is first and second electrodes with the first electrode overlying or disposed over the first side of the film layer 70 and the second electrode disposed over the second side of the film layer 70. Suitably, the active film or layer 70 is locally responsive to electric and/or magnetic fields. That is to say, at the location where an electric or magnetic field is applied across the active film or layer 70, the active film or layer 70 changes its color or reflectance or absorption or opacity or another like visually perceivable quality in response to the applied electric and/or magnetic field. For example, this change is achieved by an electrophoretic effect or other like phenomena or a similar mechanism experienced in and/or by the active layer. In a suitable embodiment, the visually observable state change is achieved via one of the mechanisism described in one of the above-mentioned patent applications. In one particular embodiment, the active layer 70 optionally includes a plastic and/or electrophoretic film containing a dielectric fluid/emulsion and/or bi-stable charged particles, e.g., in respective wells. Additionally, while illustrated as a single layer, optionally the active film 70 may in fact be a multi-layer film.

In general, to apply the electric and/or magnetic fields, electrodes on opposing sides of the active layer 70 are energized and/or otherwise used. Suitably, each element 54a-g in the overall display apparatus 50 is individually addressable so as to control and/or switch the state thereof by a display driver and/or controller (e.g., a micro-processor or the like) operatively connected to the aforementioned electrodes.

As shown, on a first side of the active layer 70, a backplane 72 or the like is optionally arranged, e.g., implemented via a printed circuit board (“PCB”) or the like. The backplane 72 includes a plurality of operative electrical connections to a plurality of first side electrodes. Optionally, the plurality of first side electrodes includes one electrode underlying and/or corresponding to every element 54a-g in each multi-element display 52 of the overall display apparatus 50. Optionally, the backplane 72 or PCB may be secured to the active layer 70 via a suitable adhesive 74. Suitably, for all the multi-element displays 52 residing in a common column, a single common connection exists and/or is optionally employed to address all the first side electrodes corresponding to those elements sharing the same relative location within their respect multi-element displays 52. That is to say, optionally, the first side electrodes corresponding to elements all sharing the same relative location within the respective multi-element displays residing in a common column of the overall display apparatus are operatively tied together. More specifically, in the present example:
the first side electrodes corresponding to all the elements 54a in the column 62a are tied together;
the first side electrodes corresponding to all the elements 54b in the column 62a are tied together;
the first side electrodes corresponding to all the elements 54c in the column 62a are tied together;
the first side electrodes corresponding to all the elements 54d in the column 62a are tied together;
the first side electrodes corresponding to all the elements 54e in the column 62a are tied together;
the first side electrodes corresponding to all the elements 54f in the column 62a are tied together;
the first side electrodes corresponding to all the elements 54g in the column 62a are tied together;
the first side electrodes corresponding to all the elements 54a in the column 62b are tied together;
the first side electrodes corresponding to all the elements 54b in the column 62b are tied together;
the first side electrodes corresponding to all the elements 54c in the column 62b are tied together;
the first side electrodes corresponding to all the elements 54d in the column 62b are tied together;
the first side electrodes corresponding to all the elements 54e in the column 62b are tied together;
the first side electrodes corresponding to all the elements 54f in the column 62b are tied together;
the first side electrodes corresponding to all the elements 54g in the column 62b are tied together;
the first side electrodes corresponding to all the elements 54a in the column 62c are tied together;
the first side electrodes corresponding to all the elements 54b in the column 62c are tied together;
the first side electrodes corresponding to all the elements 54c in the column 62c are tied together;
the first side electrodes corresponding to all the elements 54d in the column 62c are tied together;
the first side electrodes corresponding to all the elements 54e in the column 62c are tied together;
the first side electrodes corresponding to all the elements 54f in the column 62c are tied together;
the first side electrodes corresponding to all the elements 54g in the column 62c are tied together;
and so on for each of column 62d and 62e.

On the other or second side of the active layer 70, a divided second side electrode layer 76 is formed or otherwise arranged. That is to say, the second side electrode layer 76 is divided into a plurality of distinct conductors and/or electrodes 76a-c. Suitably, each distinct conductor/electrode 76a-c in the second side electrode layer 76 overlies and/or corresponds to one of the rows 60a-c in the overall display apparatus 50 (aligned with the rows or columns in the first electrode).

The second side electrode layer 76 is formed from and/or made of indium tin oxide (ITO). In production, optionally, the layer 76 is coated onto the surface of the active layer 70. To create the desired divisions in the layer 76, optionally during the coating process the ITO or other material is masked, pattern coated or otherwise processed in such a way as to produce rows which correspond to the final cut display material, e.g., so that a three row display apparatus 50 would have three corresponding strips of conductor.

In any event, with the exemplary construction described herein, to individually address (e.g., with the display driver/controller) any particular element in the overall display apparatus 50, the driver/controller merely employs: (1) the distinct second side conductor/electrode 76a-c corresponding to the row 60a-c in which the multi-element display device 52 resides that contains the element of interest (i.e., the element to be controlled); in conjunction with, (2) the particular connection in the backplane 72 assigned to and/or designated for (i) the column 62a-e in which the multi-element display device 52 resides which contains the element of interest, and (ii) the relative element location one desires to control within the multi-element display 52.

To give a particular example, if one wanted to control and/or switch the state of the top left-side element of the multi-element display device 52 in the forth column 62d of the second row 60b of the apparatus 50, the display driver/controller would energize or otherwise use the following electrodes and/or connections to apply an electric and/or magnetic field across the active layer 70:
the second side conductor/electrode 76b; and,
the connection within and/or to the backplane 72 that ties together the first side electrodes corresponding to elements 54c in the multi-element display devices 52 residing in column 62d.

It is to be appreciated, of course, that the corresponding elements 54c in column 62d and rows 60a and 60c are not addressed and/or controlled in the forgoing operation even though their associated first side electrodes are commonly tied to the same backplane connection, because the corresponding electrodes 60a and 60c are not driven or addressed in this operation.

Optionally, as shown in FIG. 4, a protective layer, coating or film 78 may be applied over the second side electrode layer 76 opposite the active film layer.

To summarize, the electrophoretic or other like display disclosed herein allows the display driver/controller to have fewer connections. Additionally, the microprocessor/chip may be smaller and the number of tracks/connections to the display can be reduced. The proposed configuration allows any segment of a multi-line or multi-row display to be individually addressable and/or controlled. In short, the present approach departs from prior art approaches at least in one respect, namely, insomuch as the second side electrode layer is partitioned into rows which may be individually controlled to allow the complete display to be multiplexed. In use, only a single electrode corresponding to a given row would be activated at a given time and only the segments under that electrode and/or in the corresponding row would be controlled at that time. This configuration allows all backplane electrodes for like segments in a common column to be connected in parallel and/or tied together, with the selected second side electrode controlling which row is active.

In any event, it is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

It will thus be seen according to the present invention a highly advantageous dynamic display with top electrode has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

What is claimed is:

1. A display, comprising:
an active film layer have first and second sides, a first electrode disposed over the first side and a second electrode disposed over the second side;
a backplane disposed between the first side of the film layer and the first electrode and having a plurality of connections to the first electrode and the first electrode divided into a plurality of rows or columns;
the second electrode divided into a plurality of rows or columns;
a display driver connected to row or column of each of the electrodes;
a plurality of multi-element displays provided for selectively displaying a plurality of variable characters, each of the multi-element display selectively depicts one of an alpha-numeric or other character by selectively controlling the state of each individual element within the particular display; and
the multi-element displays are arranged in a matrix or two-dimensional array including a plurality of rows or columns, with each row or column including one or more of the multi-element displays and each row or column of the multi-element displays corresponding to at least the row or column of the second electrode.

2. A display as recited in claim 1, wherein each of the displays is bi-stable.

3. A display as recited in claim 2, wherein the bistable display is electrophoretic.

4. A display as recited in claim 1, wherein each of the multi-element displays is a seven segment display.

5. A display as recited in claim 1, wherein each element of the multi-element display is individually addressable.

6. A display as recited in claim 1, wherein the rows or columns of the first electrode are in alignment with the rows or columns of the second electrode.

7. A display as recited in claim 1, wherein the backplane is adhesively connected to the film layer.

8. A display as recited in claim 1, wherein a protective layer is provided over the second electrode opposite the film layer.

9. A method for using a display, comprising the steps of:
providing a multi-element display having first and second electrodes disposed on either side of an active film layer, each of the first and second electrodes divided into one or more rows or columns;
connecting a display driver to each of the rows or columns of the first and second electrodes;
energizing the active film layer to provide an electric or magnetic field to a particular segment of the active film layer;
connecting the second electrode through the active film layer to the first electrode; and
creating only a display on the particular segment and not all of the film while the first electrode is energized.

10. A method as recited in claim 9, including a further step of providing a protective film over the second electrode during the step of providing a multi-element display.

11. A method as recited in claim 9, wherein the multi-element display is a seven segment display.
